(19) United States
(12) Patent Application Publication
(10) Pub. No.: US 2002/0137832 A1
(43) Pub. Date: Sep. 26, 2002

(54) Drip resistant polymer composition

(76) Inventors: Samuel A. Ogoe, Missouri City, TX (US); Chai-jing Chou, Missouri City, TX (US); Donna C. Scott, Brazoria, TX (US); Hani Farah, Sugar Land, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/738,029

(22) Filed: Dec. 13, 2000

Related U.S. Application Data
(60) Provisional application No. 60/171,417, filed on Dec. 21, 1999.

(51) Int. Cl. C08K 3/34

(52) U.S. Cl. 524/445; 524/447; 524/585; 524/586; 524/582; 524/584; 524/464; 524/409; 524/127; 524/462

(57) ABSTRACT

This invention relates to thermoplastic polymer compositions comprising a clay having drip resistance in the Underwriters Laboratories Standard 94 flammability test.

### CROSS REFERENCE STATEMENT

This application claims the benefit of U.S. Provisional Application No. 60/171,417, filed Dec. 21, 1999.

### FIELD OF THE INVENTION

This invention relates to polymer compositions having drip resistant properties, and more particularly to thermoplastic compositions comprising a clay having drip resistance in the Underwriters Laboratories Standard 94 flammability test.

### BACKGROUND OF THE INVENTION

Improvement of the fire resistance or ignition resistance properties of polymers has long been a goal of polymer compounders. Ignition resistance is typically evaluated by the Underwriters Laboratories Standard 94 (UL 94, ASTM procedure D 3801). In this test, two charateristics of the polymer are evaluated, the length of flaming combustion following the application of a test flame and, once exposed to the test flame, the ability of the polymer to maintain its physical integrity, in other words whether the specimen drips or not.

Different polymers have different combustion mechanisms which require different approaches to impart ignition resistance. Typically, flaming resistance is imparted to thermoplastic polymers by compounds that act as free radical scavenger in the gas phase to extinguish the flame and/or compounds that promote charring to reduce the amount of available combustible fuel. Examples of free radical scavengers are halogenated hydrocarbons, preferably chlorinated and most preferably brominated hydrocarbons and phosphorous containing compounds, preferably organophosphates. Often, compounds that synergistically improve the effectiveness of the free radical scavengers are used, for example antimony oxide. The most common char promoters are phosphorous containing compounds and metal salts, such as alkali metal salts of sulfur containing compounds.

The most common drip suppressant used in thermoplastic polymers is tetrafluoroethylene polymers, such polymers are sometimes referred to as polytertafluoroethylene (PTFE) or Teflon and are disclosed for example in USP 3,005,795, 3,671,487 and 4,463,130. Preferably, the tetrafluoroethylene polymers form a fibril structure to stabilize the thermoplastic polymer under molten conditions. Most desirably the tetrafluoroethylene polymers have a high elastic memory. An effective amount of PFTE polymer to impart drip resistance is usually in the range of about 0.01 to 5 weight percent of the total thermoplastic polymer composition. Unfortunately, such compounds have significant drawbacks. The elastic memory, and thus the effectiveness as a drip suppressant, of such compounds is a function of the thermoplastic polymer composition's heat and processing history. Often, thermoplastics containing PFTE polymers loose their drip suppressant characteristics if they are reground or recycled. Further, PFTE compounds can detrimentally effect the physical and flammability properties of thermoplastic compositions. For example, see WO 99/43747 which shows that antimony free thermoplastic polymer blends compositions with a PFTE polymer containing an organophosphate as the sole flame retardant agent and a synergistic amount of an organoclay demonstrate degraded flame retardant properties as compared to similar compositions without the PFTE polymer. It is well known that PFTE compounds can adversely effect the impact resistance of thermoplastic compositions, specifically the notched Izod impact strength. Additionally, PFTE polymers can cause unacceptable blemishes on the surface of the final molded articles.

PFTE free thermoplastic compositions are known. For example, see U.S. Pat. No. 4,582,866 which teaches a multi-block copolyester elastomer composition containing a bromine-containing flame retardant, antimony oxide and an organoclay. While these compositions obtain the V-0 rating some specimens still exhibited dripping during in the UL 94 flammability test. EP 132,228 disclosed a reinforced polyester composition with up to 50 weight percent filler, a flame retardant additive, an organoclay and an alkali metal salt of an aliphatic monocarboxylic acid, but such high levels of filler can negatively effect physical properties, in particular impact strength. The present invention addresses these problems.

### SUMMARY OF THE INVENTION

Accordingly, the present invention is directed to a thermoplastic polymer composition comprising an effective amount of clay to improve the drip resistance of the thermoplastic polymer in the UL 94 flammability test. Preferably, the thermoplastic polymer is a polypropylene, polycarbonate, polystyrene, polyester, ABS, nylon or thermoplastic polyurethane and the clay is an organoclay.

In a further embodiment, the present invention involves a method for preparing the drip resistant thermoplastic polymer composition described hereinabove.

In yet a further embodiment, the present invention involves a method for producing a molded or extruded article of the drip resistant thermoplastic polymer composition described hereinabove.

In yet a further embodiment, the present invention involves the drip resistant thermoplastic polymer composition described hereinabove in the form of a molded or extruded article.

### DETAILED DESCRIPTION OF THE EMBODIMENTS

Component (a) in the polymer composition of the present invention is a thermoplastic polymer. The thermoplastic polymers can be homopolymers or copolymers. Preferably, the thermoplastic polymer which is beneficially drip resistant modified by the addition of clay can be a polyolefin, a polycarbonate (PC), a polystyrene (PS), a polyester, an acrylonitrile, butadiene and styrene copolymer (ABS), a nylon, a thermoplastic polyurethanes (TPU, e.g., PELLATHANETM™ or ISOPLAST™ made by The Dow Chemical Company), and blends thereof. Generally the polyolefin polymers which are most frequently used are polyethylene (PE) and polypropylene (PP) made by conventional Ziegler-Natta or metallocene catalysts.

The polypropylene suitable for use in this invention is well known in the literature and can be prepared by known techniques. In general, the polypropylene is in the isotatic form of homopolymer polypropylene, although other forms of polypropylene can also be used (e.g., syndiotatic or atatic). Polypropylene impact copolymers (e.g., those wherein a secondary copolymerization step reacting ethylene with the propylene is employed), however, can also be used in the polymer compositions disclosed herein. A complete discussion of various polypropylene polymers is contained in Modern Plastics Encyclopedia/89, mid October 1988 Issue, Volume 65, Number 11, pp. 86-92, the entire disclosure of which is incorporated herein by reference. The molecular weight of the polypropylene for use in the present invention is conveniently indicated using a melt flow measurement, sometimes referred to as melt flow rate (MFR) or melt index (MI), according to ASTM D 1238, under conditions of 230° C. at an applied load of 2.16 kilogram (kg). Melt flow rate is inversely proportional to the molecular weight of the polymer. Thus, the higher the molecular weight, the lower the melt flow rate, although the relationship is not linear. The melt flow rate for the polypropylene useful herein is generally greater than about 0.1 grams per 10 minutes (g/10 min), preferably greater than about 0.5 g/10 min, more preferably greater than about 1 g/10 min, and even more preferably greater than about 10 g/10 min. The melt flow rate for the polypropylene useful herein is generally less than about 100 g/10 min, preferably less than about 75 g/10 min, more preferably less than about 60 g/10 min, and more preferably less than about 50 g/10 min.

Component (b) in the compositions of this invention is a clay. The clays best suited for use are hydrous alumino silicate-type compounds, generally represented by the formula:

Al₂O₃·SiO₂·2H₂O.

Preferably, the clay is an organoclay. As used herein, organoclay means a layered clay, derived from a layered mineral and in which organic moieties have been chemically incorporated, ordinarily by ion exchange and especially cation exchange with organic ions and/or onium compounds. More preferably, the organoclay is the reaction product of at least one quaternary ammonium salt with a smectite-type clay having an ion exchange capacity of at least 75 milliequivalents per 100 gram (meq/100 g) of clay, the quaternary ammonium salts having the formula

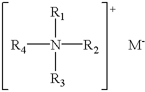

Wherein M⁻ is selected from the group consisting of chloride, bromide, iodide, nitrite, hydroxide, acetate, methyl sulfate and mixture thereof, wherein R₁ is an alkyl group having 12 to 22 carbon atoms and wherein R2,R3 and R4 are selected from the group consisting of hydrogen, alkyl groups containing 1 to 22 carbon atoms, aryl groups and aralkyl groups containing 1 to 22 carbon atoms in the alkyl chain.

Smectite-type clays which are useful in preparing the required organoclays include bentonite, montmorillonite, hectorite, and saponite clays with bentonite and hectorite clays being preferred. The clays should have an ion exchange capacity of at least 75 meq/100 g of clay and preferably at least 95 meq/100 g of clay. Useful quaternary ammonium salts for modifying the clay by ion exchange must contain a cation having at least one long chain alkyl substitute having 12 to 22 carbon atoms. For reasons of economy most commercially available useful quaternary ammonium salts have one or more alkyl groups derived from hydrogenated tallow which is principally an octadecyl group. The preferred anion is the chloride ion. Representative quaternary ammonium salts which are useful in preparing the organoclays required by the present invention include methyl benzyl di(hydrogenated tallow) ammonium chloride, dimethyl benzyl di(hydrogenated tallow) ammonium chloride, dimethyl di(hydrogenated tallow) ammonium chloride, methyl tri(hydrogenated tallow) ammonium chloride, and benzyl tri(hydrogenated tallow) ammonium chloride. An especially preferred organoclay is CLAYTONE™ HY, a montmorillonite cation exchanged with diethyl di(hydrogenated tallow) ammonium ion available from Southern Clay Products, and montmorillonite cation exchanged with such ions as dodecylimidazolium, trimethyldodecylimidazolium, N,N'-dodecylimidazolium, N,N'-ditetradecyl-benzimiazolium or methyl bis(hydroxyethyl)-(hydrogenated tallow) ammonium.

The organoclays are present in an effective amount to improve the drip resistance of the thermoplastic polymer in the UL 94 test. Generally, the organoclay is present in an amount equal to or greater than about 0.01 part by weight based on the weight of the polymer composition, preferably equal to or greater than about 0.1 part by weight, more preferably equal to or greater than about 1 part by weight, even more preferably equal to or greater than about 2 parts by weight, and most preferably equal to or greater than about 5 parts by weight based on the weight of the polymer composition. Generally, the organoclay is present in an amount less than or equal to about 35 weight percent based on the weight of the polymer composition, preferably less than or equal to about 25 parts by weight, more preferably less than or equal to about 15 parts by weight, even more preferably less than or equal to about 10 parts by weight, and most preferably less than or equal to about 5 parts by weigh based on the weight of the polymer composition.

Further, the claimed polymer compositions may also optionally contain one or more additives that are commonly used in polymer compositions of this type. Preferred additives of this type include, but are not limited to: impact modifiers such as, but not limited to core-shell graft copolymers; fillers, such as, but not limited to talc, mica, wollastonite, glass or a mixture thereof; ignition resistance additives; slip agents, such as of erucamide, oleamide, linoleamide, or steramide; mineral oils; stabilizers, such as heat stabilizers, light stabilizers, ultra violet stabilizers; colorants; antioxidants; antistats; flow enhancers; mold releases, such as metal stearates (e.g., calcium stearate, magnesium stearate); nucleating agents, including clarifying agents, etc. Preferred examples of additives are ignition resistance additives, such as, but not limited to halogenated hydrocarbons, halogenated carbonate oligomers, halogenated diglycidyl ethers, organophosphorous compounds, fluorinated olefins, antimony oxide and metal salts of aromatic sulfur, or a mixture thereof may be used.

If used, such additives may be present in an amount from at least about 0.01 parts, preferably at least about 0.1 parts, more preferably at least about 1 parts, more preferably at least about 2 parts and most preferably at least about 5 parts by weight based on the total weight of the polymer composition. Generally, the additive is present in an amount less than or equal to about 25 parts, preferably less than or equal to about 20 parts, more preferably less than or equal to about 15 parts, more preferably less than or equal to about 12 parts, and most preferably less than or equal to about 10 parts by weight based on the total weight of the polymer composition.

Preparation of the polymer compositions of this invention can be accomplished by any suitable mixing means known in the art, including dry blending the individual components and subsequently melt mixing, either directly in the extruder used to make the finished article, or pre-mixing in a separate extruder (e.g., a Banbury mixer). Dry blends of the compositions can also be directly injection molded without pre-melt mixing.

The polymer compositions of the present invention are thermoplastic. When softened or melted by the application of heat, the polymer compositions of this invention can be formed or molded using conventional techniques such as compression molding, injection molding, gas assisted injection molding, calendering, vacuum forming, thermoforming, extrusion and/or blow molding, alone or in combination. The polymer compositions can also be formed, spun, or drawn into films, fibers, multi-layer laminates or extruded sheets, or can be compounded with one or more organic or inorganic substances, on any machine suitable for such purpose. The polymer compositions of the present invention are preferably injection molded. Some of the fabricated articles include information technology equipment housings, for example housings for monitors, central processing units, printers, etc.; copier covers; keyboards; hand held communication devices, such as pagers, cellular phones, hand held computers, etc.; electronic equipment housings; network interface housings; plenums; television cabinets and the like.

To illustrate the practice of this invention, examples of the preferred embodiments are set forth below. However, these examples do not in any manner restrict the scope of this invention.

### EXAMPLES

The compositions of Examples 1 to 8 and Comparative Examples A to G were prepared by mixing the dry components and then feeding the dry-blended formulation through a 30 millimeter (“mm”) Werner and Pfleider twin screw extruder. Typical compounding conditions on the Werner and Pfleider extruder were: Barrel temperature profile: 220 to 230° C.; Melt temperature: 225 to 230° C.; RPM: 250; Torque: 70 to 80 percent; and Feed rate: 50 pounds per hour. The extrudate is cooled in the form of strands and comminuted as pellets. The pellets were used to prepare 5 by 0.5 by 0.062 inch test specimens on a 70 ton Arburg injection molding machine, typical molding conditions were: Barrel temperature: 220° C.; Mold temperature: 40° C; Injection pressure: 40 to 50 bar; Holding pressure: 35 bar; Screw speed: 2; Injection speed: 2; Cycle time: 30 seconds; Cooling time: 15 seconds; and Dosage: 12.5.

The formulation content and drip resistant performance of Examples 1 to 8 and Comparative Examples A to G are given in Table 1 below in parts by weight of the total composition. In Table 1:

“PP” is a commercially available homopolymer of polypropylene available having a MFR of 1 under conditions of 230° C./2.16 kg available from Montell;

“ABS” is a commercially available acrylonitrile, butadiene and styrene copolymer available as MAGNUMTM™F-430 from The Dow Chemical Company;

“PS” is a commercially available high impact polystyrene available as STYRONTM™ 220 from The Dow Chemical Company;

“TPU” is a commercially available thermoplastic urethane available as PELLETHANE 2103-80 AE from The Dow Chemical Company;

“Clay” is a commercially available montmorillonite cation exchanged with diethyl di(hydrogenated tallow) ammonium ion available as CLAYTONE HY from Southern Clay Products;

“Talc” is a commercially available mineral talc having a maximum particle size of 10 micrometer and a weight average diameter of 1.0 micrometer available as TALCRONTM™ MP-10-52 from Specialty Minerals, Inc.;

“BT-93” is a commercially available ethylene bis-tetrabromophthalimide available as SAYTEXTM™BT-93 from Albemarle Corporation;

“Deca” is a commercially available decabromodiphenyloxide available as SAYTEX 102 from Albemarle Corporation;

“Sb” is a commercially available antimony oxide available as FIRESHIELD™ H from Laurel Industries, Inc., and “UL 94” is the Underwriters Laboratories standard 94 vertical flame test (ASTM 3801), test specimens were 0.062 inches thick.

TABLE 1

| | | | | | | | | | | | | | Comparative | | |
|---|---|---|---|---|---|---|---|---|---|---|---|---|---|---|---|
| | Comparative Example | | | | | Example | | | | | | | Example | | Example |
| COMPOSITION | A | B | C | D | E | 1 | 2 | 3 | 4 | 5 | 6 | 7 | F | G | 8 |
| PP | 100 | 75 | 90 | 62 | 62 | 90 | 65 | 62 | | | | | | | |
| PS | | | | | | | | | 90 | 95 | | | | | |
| ABS | | | | | | | | | | | 90 | 95 | | | |
| TPU | | | | | | | | | | | | | 100 | 90 | 90 |
| Clay | | | | | | 10 | 10 | 10 | 10 | 5 | 10 | 5 | | | 10 |
| Talc | | | 10 | 10 | 10 | | | | | | | | | 10 | |
| BT-93 | | 20 | | 21 | | | 20 | | | | | | | | |
| Deca | | | | | 21 | | | 2 | | | | | | | |
| | | | | | | | | 1 | | | | | | | |
| Sb | | 5 | | 7 | 7 | | 5 | 7 | | | | | | | |
| UL 94, 0.062 in. | | | | | | | | | | | | | | | |
| Rating | NR | V-2 | NR | V-1 | V-2 | NR | V-0 | V-0 | NR | NR | NR | NR | NA | NA | NA |
| Flaming Drips | yes | yes | yes | no | yes | no | no | no | no | no | no | no | yes | yes | no |
| Time to 1^{st} drip, sec. | NA | NA | 12 | 0 | 7 | 0 | 0 | 0 | 0 | 0 | 0 | 0 | 2 | 1 | 0 |

NR = not rated
NA = not available

What is claimed is:

1. A polymer composition comprising:
(a) a thermoplastic polymer and
(b) an effective amount of clay to improve the drip resistance of the thermoplastic polymer in the UL 94 flammability test.

2. The composition of claim 1 wherein the clay is an organoclay.

3. The composition of claim 2 wherein the organoclay is prepared from a Smectite-type clay selected from the group consisting of bentonite, montmorillonite, hectorite and saponite clays.

4. The composition of claim 1 wherein the clay is CLAYTONE HY.

5. The composition of claim 1 wherein the thermoplastic polymer is selected from the group consisting of polyethylene, polypropylene, polycarbonate, polystyrene, polyester, ABS, nylon and thermoplastic polyurethane.

6. The composition of claim 1 wherein the thermoplastic polymer is polypropylene.

7. The composition of claim 1 where in the clay is present in an amount from about 1 percent to about 20 percent by weight of the total composition.

8. The composition of claim 1 further comprising an effective amount of one or more flame retardant additives to produce a V-0 rating in the UL 94 flammability test.

9. The composition of claim 8 wherein the flame retardant additives are selected from the group consisting of brominated or chlorinated organic compounds, phosphate-based compounds, antimony compounds, alkali metal salts, alkali metal acids, and fluorine compounds.

10. The composition of claim 9 free from a tetrafluoroethylene polymer.

11. A method for preparing a polymer composition comprising the step of combining:
(a) a thermoplastic polymer and
(b) an effective amount of clay to improve the drip resistance of the thermoplastic polymer with regard to UL 94 flammability test.

12. A method for producing a molded or extruded article of a polymer composition comprising the steps of:
(1) preparing a propylene polymer composition comprising:
(a) a thermoplastic polymer and
(b) an effective amount of clay to improve the drip resistance of the thermoplastic polymer with regard to UL 94 flammability test; and
(2) molding or extruding said propylene polymer composition into molded or extruded article.

13. The composition of claim 1 in the form of a molded or extruded article.
